(19) United States
(12) Patent Application Publication
(10) Pub. No.: US 2012/0202667 A1
(43) Pub. Date: Aug. 9, 2012

(54) UNISEX ZIPPERED PACKAGES WITH WIDE MOUTH AND OTHER FEATURES

(75) Inventors: Charles G. GRECO, Bardonia, NY (US); David J. ANZINI, Middletown, NY (US); Lars WIHLBORG, Stratford, CT (US); Rusty KOENIGKRAMER, Nanuet, NY (US)

(73) Assignee: ILLINOIS TOOL WORKS INC., Glenview, IL (US)

(21) Appl. No.: 13/193,030

(22) Filed: Jul. 28, 2011

Related U.S. Application Data
(60) Provisional application No. 61/368,496, filed on Jul. 28, 2010.

(51) Int. Cl. B31B 39/00

(52) U.S. Cl. 493/210

(57) ABSTRACT

The disclosure pertains to method for manufacturing reclosable packages, bags or pouches wherein, typically, a unisex zipper is looped and sealed inside of the package. The formation of the looped zipper segment causes the package to have a wide open mouth, and a natural tendency toward the open configuration. Both transverse and machine direction methods are disclosed, as well as resulting packages which may include a spout.

This application claims priority under 35 U.S.C. §119(e) of U.S. provisional application Ser. No. 61/368,496 filed Jul. 28, 2010, the disclosure of which is hereby incorporated by reference in its entirety.

### BACKGROUND OF THE DISCLOSURE

1. Field of the Disclosure

The present disclosure pertains to unisex zippered reclosable packages with a wide mouth opening feature and/or easy open and/or easy close features. The present disclosure further pertains to wide mouth opening pre-made or horizontal form, fill and seal pouches. The present disclosure further pertains to pre-made or horizontal form, fill and seal pouches with pour spout reclosures.

2. Description of the Prior Art

Wide mouth gusseted packages are disclosed by U.S. Published Patent Application No. 2007/0258665 entitled “Wide Mouth Gusseted Packages”, published on Nov. 8, 2007 on behalf of Greco. While the Greco reference is well-adapted for its intended purposes, further improvements are sought with respect to simplifying the manufacturing process, particularly in transverse direction (TD) applications.

Additionally, while vertical form fill seal (VFFS) machines are well-adapted for their intended purposes, some VFFS applications which include transverse placement of the joined zipper can deal with issues such as a propensity for inner flange sealing exacerbated by poor heat transfer films; slide between the male and female zipper elements resulting in “inch worming” or open zippers jamming the equipment; lateral movement of elements resulting in offset elements that jam in the cassette or on the lip of the filling tube; poor stomping of joined zipper ends required to prevent slide of male and female elements or to promote ease of closure which then fail upon forcibly being opened to full mouth opening; premature knife wear as a result of cutting the two elements together; and zipper camber due to unbalanced flanges and the complexity of different sized flanges resulting in unreliable zipper transport or jumping off of or out of the guide, improper placement of the zipper, or unwanted zipper curvature.

Additionally, such applications may require jaw modifications in order to operate properly. The sealing of consumer side flanges to fim may require more actions to take place under difficult operating conditions. The high heat conditions and the requirement to make these flange seals can also promote hot tack failure between the flanges and the film.

Similarly, some current transverse direction zipper production applications may incur increased costs. These increased costs may occur due to joining equipment which increases scrap and reduces production speeds, increased sensitivity to winding conditions, the use of more expensive materials to prevent inner flange sealing, increased costs of sealant layers and the inherent complexity of working with male/female profiles.

Moreover, the opening of some reclosable pouches may be restricted or smaller than the full mouth opening because of the zipper. In some transverse direction processes, it is necessary for the zipper to be shorter than the pouch in order to insert the zipper into the pouch. In addition, the zipper may be stomped which reduces the opening even further. Moreover, ease in opening is not always fully satisfactorily achieved by a pouch manufactured in a transverse direction application. Additionally, some single profiles to not close as well as some double zipper profiles.

In a pillow-type bag, the percentage mouth opening lost is relatively small compared to that of gusseted bags, yet the end stomps of the zipper still remove some the mouth opening in the pillow bag. Many current gusseted bags use a zipper that is short of the width of the bag's front panel, thereby restricting the opening size of the bag. In many applications, it is desirable that the opening of a pillow or gusseted bag be as large as possible to enable ease of scooping out or pouring out the product, or filling.

### OBJECTS AND SUMMARY OF THE DISCLOSURE

It is therefore an object of the present disclosure to provide improvements in wide mouth gusseted reclosable packages or bags.

It is therefore a further object of the present disclosure to provide improvements in gusseted bags with respect to increased width of mouth, increased ease of opening and/or increased ease of closing.

These and other objects are attained in the first and second embodiments of the disclosure by providing a package, pouch or bag, that includes a zipper reclosure which is typically a unisex style zipper, possibly including double profiles. The zipper is attached to the pouch film by a transverse direction process. Because the zipper is a unisex type zipper, it can be fully attached to the film in a transverse direction application. The zipper is attached to the full width of the pouch film at the applicator position. The zipper can have one or two flanges. The flanges are sealed to the pouch film in the transverse direction applicator.

These and other objects are attained in a third embodiment of the disclosure by applying a unisex zipper in the transverse direction to the full width of the film web on a VFFS machine. The web is formed and folded by the VFFS machine. Often the machine will form a bag with side gussets.

These and other objects are attained in a fourth embodiment of the disclosure wherein the unisex style zipper is pre-looped and then applied in the machine direction, inboard of the pouch side welds.

These and other objects are attained in a fifth embodiment of the disclosure, which builds on a fourth embodiment of the disclosure by utilizing a smaller zipper loop that partially covers one side of the package forming a spout. Placement of the zipper loop segment into the package is not limited to transverse direction or pre-applied methods in that machine direction placement is possible.

### BRIEF DESCRIPTION OF THE DRAWINGS

Further objects and advantages of the invention will become apparent from the following description and from the accompanying drawing, wherein:

FIG. 1 is a first perspective view of a first embodiment of the present disclosure, showing a reclosable package, using a unisex zipper, in a closed configuration.

FIG. 2 is a second perspective view of a first embodiment of the present disclosure, showing a reclosable package in an open configuration.

FIG. 3 is a first perspective view of a second embodiment of the present disclosure, showing a reclosable package, using a double unisex zipper, in an open configuration.

FIG. 4 is a second perspective view of a second embodiment of the present disclosure, showing a reclosable package in a closed configuration.

FIG. 5 is a plan view of a third embodiment of the present disclosure, a unisex zipper with a notched profile applied transversely on a web.

FIG. 6 is a perspective view of a third embodiment of the present disclosure, a unisex zipper in combination with a fin seal.

FIG. 7 is a cross-sectional view of a typical zipper profile, a double unisex multiple alignment zipper, used in the fourth and fifth embodiments of the present disclosure.

FIGS. 8A and 8B illustrate the looping of a zipper profile, a step used in the fourth and fifth embodiments of the present disclosure.

FIG. 9 illustrates the compressing of a looped zipper profile, a step used in the fourth and fifth embodiments of the present disclosure.

FIG. 10 illustrates the placement of a compressed looped zipper profile into a pouch, a step used in the fourth embodiment of the present disclosure.

FIG. 11 illustrates the opening of the compressed loop zipper profile in a pouch, a step used in the fourth embodiment of the present disclosure.

FIG. 12 illustrates a series of zipper loops attached to a carrier web, a step used in the fourth and fifth embodiments of the present disclosure.

FIG. 13 illustrates a first variation of the fifth embodiment of the present disclosure, a reclosable package or bag with a pour spout.

FIG. 14 illustrates a second variation of the fifth embodiment of the present disclosure, a reclosable package or bag.

FIG. 15 illustrates a first variation of the fifth embodiment of the present disclosure, a reclosable package or bag, shown in the open position.

### DETAILED DESCRIPTION OF THE PREFERRED EMBODIMENTS

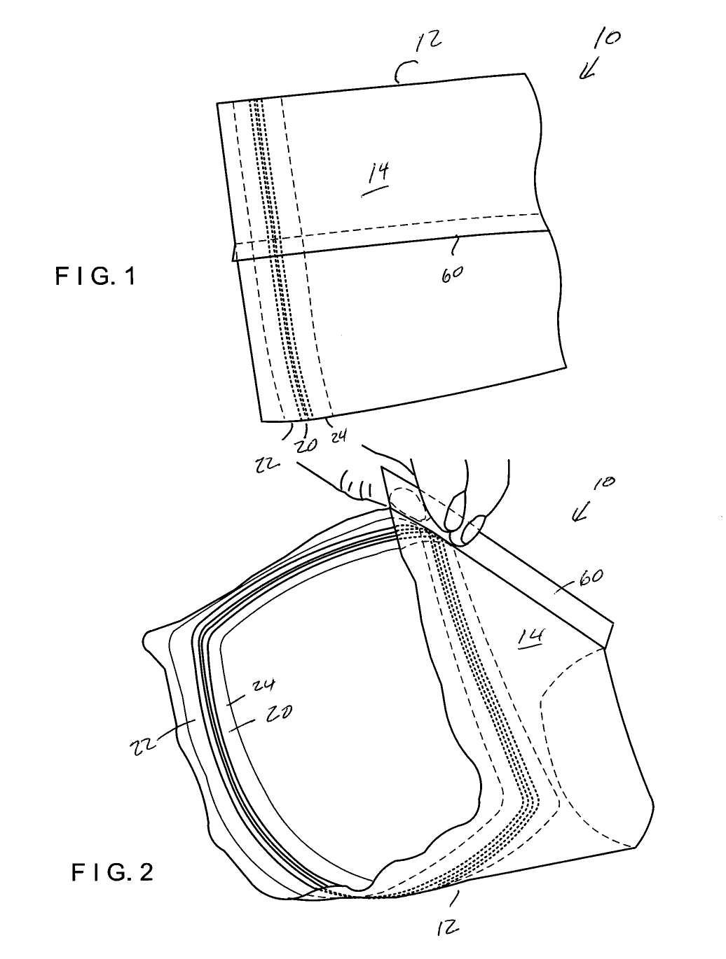

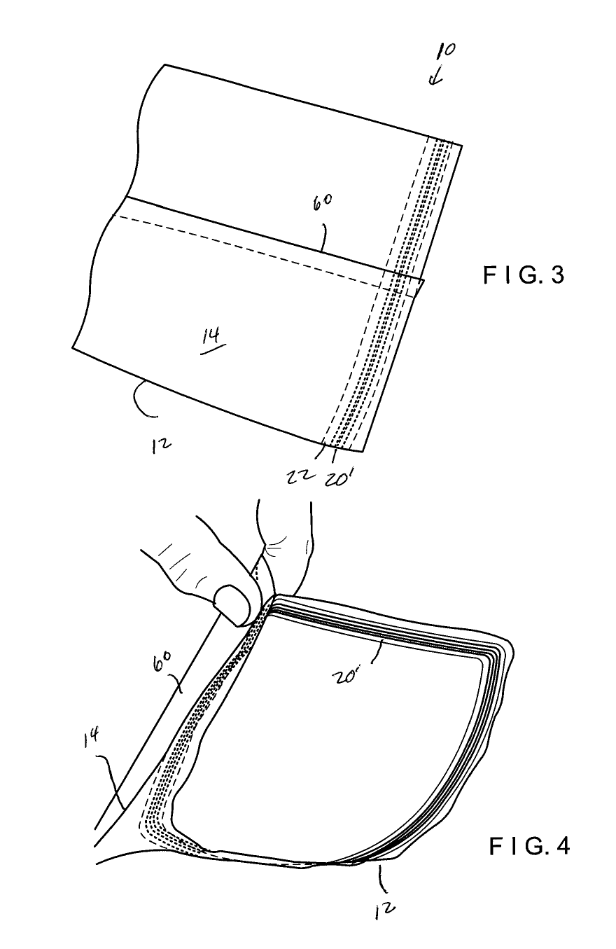

Referring now to the drawings in detail wherein like numerals indicate like elements throughout the several views, one sees that FIGS. 1 and 2 disclose a first embodiment of the disclosure, including a package 10, formed from front wall 12 and rear wall 14 (including fin seal 60), and a double profile, unisex style zipper 20, illustrated as including two flanges 22, 24. FIGS. 3 and 4 disclose a similar second embodiment of the disclosure, including a package 10 and a unisex multiple alignment zipper 20′, illustrated as including one flange 22. A unisex zipper is one which can be folded and mated or interlocked with itself.

In both the first and second embodiments, the zipper 20 or 20′ is fully attached in a transverse direction to the film which is subsequently folded to form front and rear walls 12, 14 of package 10. This full attachment is performed by a transverse direction applicator. The zipper 20 or 20′ is attached to the full width of the film at the applicator position. See FIG. 5 of the third embodiment for an illustration of a zipper in a transverse direction across a web. All flanges are sealed to the pouch film in the transverse direction applicator.

Both the first and second embodiments are produced by forming the pouch over a vertical form fill seal (VFFS) fill tube, in pillow pouch fashion. The zipper 20 or 20′ is intended to be free of end stomps and is formed in a circle around the fill tube along with the film. As the pouch makes its way to the seal jaws of the VFFS apparatus, the package 10 is sealed above the zipper 20 or 20′ with the intention that the zipper 20 or 20′ is not hit by seal jaws forming the bottom of the subsequent package or pouch. The pouch can be cut to open or perforated to open. In the case of a consumer application, the top may frequently not be sealed, but merely cut off as the bottom of the next bag is sealed in the jaws. FIGS. 1 and 3 are illustrations of the package 10 with the zipper 20 or 20′ sealed and the package 10 closed above the zipper 20 or 20′. The package 10 may be left open and unfilled until a subsequent process.

Because the pouch was preferably created without the zipper 20 or 20′ hitting the seal jaws of the VFFS equipment, no permanent deformation of the zipper 20 or 20′ is expected. Therefore, the pouch created is essentially a sealed tube of film with a zipper 20 or 20′ attached in the transverse direction along the entire circumference. Because the pouch was created with the film in tubular or circular form, the natural tendency of the film is typically to stay open in the tube shape, as shown in FIGS. 2 and 4. This is counteracted at the bottom of the package 10 by the bottom seal 30 created by the seal jaws to close the bottom of the bag. Prior art zippers with end stomps in the zipper, and wherein the zipper is attached to the pouch in the flat state, typically have a tendency to remain in a flat and interlocked state rather than a circular state.

In contrast to the prior art, because the zipper 20 or 20′ of the first and second embodiments has been sealed to the film back at the transverse direction application, it is formed into a circle at the point in the process where the pouch ends are sealed together. Therefore, the natural tendency of the zipper 20 or 20′, unless interlocked, is to keep the pouch or package 10 open, as generally shown in FIGS. 2 and 4, like the film was as it went over the forming tube.

The package 10 of first and second embodiments 10, 10′ is well-adapted as a consumer storage bag. The tendency of the package 10 to remain open when the zipper is not interlocked is desirable to many consumers who may hold the package or bag 10 with one hand, while the mouth of the bag remains wide open, which will make it much easier to fill than a typical consumer bag.

This disclosure further includes improvements in form fill seal pouches in that the wide mouth feature of the pouch will allow the user to efficiently dispense the contents. In the first embodiment, reclosure of the pouch has been rendered easier through the double unisex profile zipper logic. The combination of double profile with a multi-alignment or unisex profile design creates the most forgiving package from a reclosure point of view. In either the first or second embodiment, the zipper could be designed to have a single flange or could have two flanges of equal or different lengths. The profile could be placed in the center of the two flanges to form a symmetric design but it could also be an asymmetric design.

In both the first and second embodiments, the use of a unisex zipper across the full web width will produce a process that addresses many of the problems of current transverse directional processes, resulting in more process latitude and higher pouch making or process speeds and improved commercial prospects. In summary, the following concerns are expected to be addressed by the first and second embodiments:

1. Sealing the zipper to the film from the zipper side in front of the tube eliminates or reduces propensity for inner flange sealing exacerbated by poor heat transfer films.

2. Sealing the zipper to the film from the zipper side eliminates or reduces the need for jaw modifications and tight registration requirements between zipper placement and the jaws.

3. Using one continuous unisex zipper element eliminates or reduces male/female slide between the elements and thus “inch worming”, open zipper or lateral movement causing jamming within the FFS equipment in the cassette or on the lip of the tube.

4. Elimination of stomping is expected to achieve various advantages.

5. Knife life is increased because only a single element zipper is being used versus double the mass.

6. Using a continuous unisex zipper should reduce camber and promote straight zipper, good zipper transport and positioning of the zipper.

Moreover, production costs are typically reduced as less costly materials are used, no joining is required, less sensitive winding is required, and less complex profiles typically have reduced scrap.

The first and second embodiments are typically expected to achieve many or all of the following advantages:

1. The resulting package will open up wide and stay open thereby allowing the user to use one hand to manipulate the bag, leaving one hand free for easier filling.

2. An improved form fill seal pouch allows for ease of product dispensing.

3. An improved and reliable transverse direction manufacturing process is achieved.

4. A fully open pouch may be achieved, without losses caused by gussets, stomping or a zipper shorter than full bag width.

5. Reduced cost zipper may be used in that the need for high density polyethylene is eliminated or reduced, the need for film may be eliminated or reduced, and linear low density polyethylene materials are expected to be able to be run at higher speeds.

6. The pouch may be easier to close in view of the unisex multiple alignment double zipper profile.

7. Zipper cutting and feeding may be simplified with reduced mass, no male/female slide, and reduced camber.

8. Zipper sealing is simplified due to the expected reduction or elimination of jaw modifications (particularly those which would otherwise be done in response to changes of film) and the expected reduction or elimination of hot tack problems.

9. As the zipper is not sealed in the jaw area, a more robust process is possible.

10. The need for ultrasonics may be reduced or eliminated.

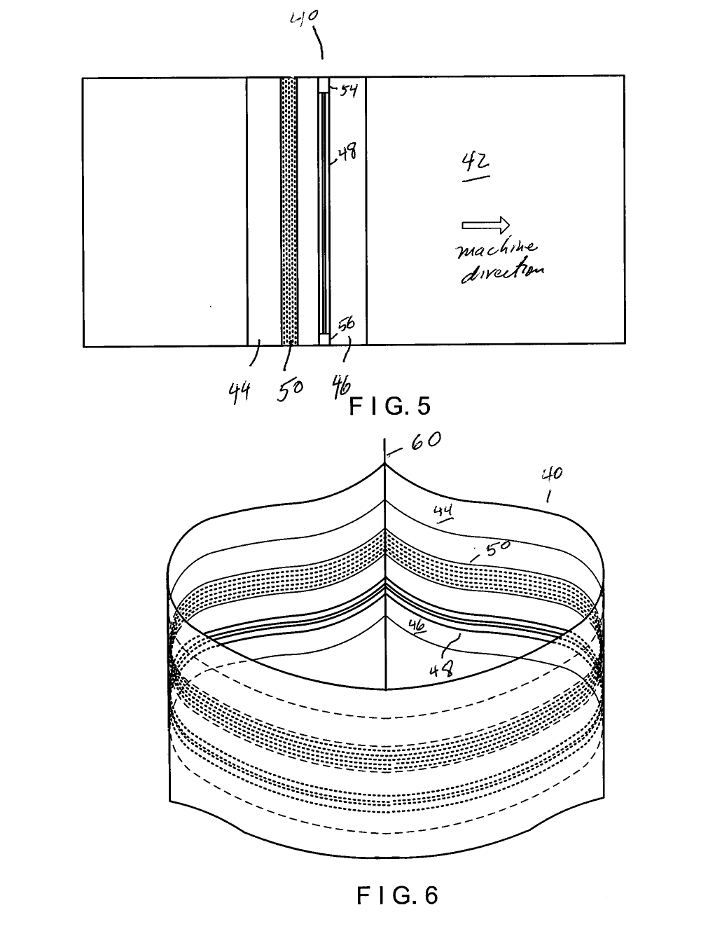

The third embodiment of the present disclosure is illustrated in FIGS. 5 and 6. This embodiment adds hermeticity to the packages of the first and second embodiments by adding a peel seal coating to the flange above the profile. As shown in FIG. 5, a unisex zipper segment 40 (single or double flange zipper segments may be used) is applied in the transverse direction to the full width of the film web 42 on a VFFS machine. The web 42 is formed and folded by the VFFS machine. While not illustrated, the resulting package may include side gussets. As described with respect to the first and second embodiments, the use of a unisex zipper also allows for a full mouth opening for gusseted bags. However, the web 42 which forms the walls of the bag or package cannot be perforated if hermeticity is desired. However, hermeticity can be achieved by the structure of FIG. 5, including the addition of the peel seal 50. The zipper segment 40 includes first and second flanges 44, 46 as well as interlocking profile 48. Additionally, a strip of peel seal material 50 is provided on first flange 44. Additionally, to maintain a hermetic seal in and around the fin seal 60 (see FIG. 6) of the resulting package, the interlocking profile 48 is shortened at its two ends thereby forming notches 54, 56. The interlocking profile 48 and perhaps part of a flange of the zipper segment 40 is notched out of the zipper segment 40 prior to application to the film or web 42. The zipper is then cut into segments leaving part of the notches 54, 56 on both the leading and trailing edges of the zipper segment 40. The zipper segment 40 is attached to the web or film 42 in the transverse direction and the film 42 and zipper segment 40 are sent to the VFFS machine. The parts of the zipper that have been notched are folded into the fin 60 of the packaging and sealed into the fin 60. The first flange 44, including peel seal material 50, is included into the fin 60, where it is sealed into the fin 60. The heat activation of the peel seal is carried over from the bulk of the zipper segment 40 into the fin 60 also, which will insure that a hermetic seal is achieved.

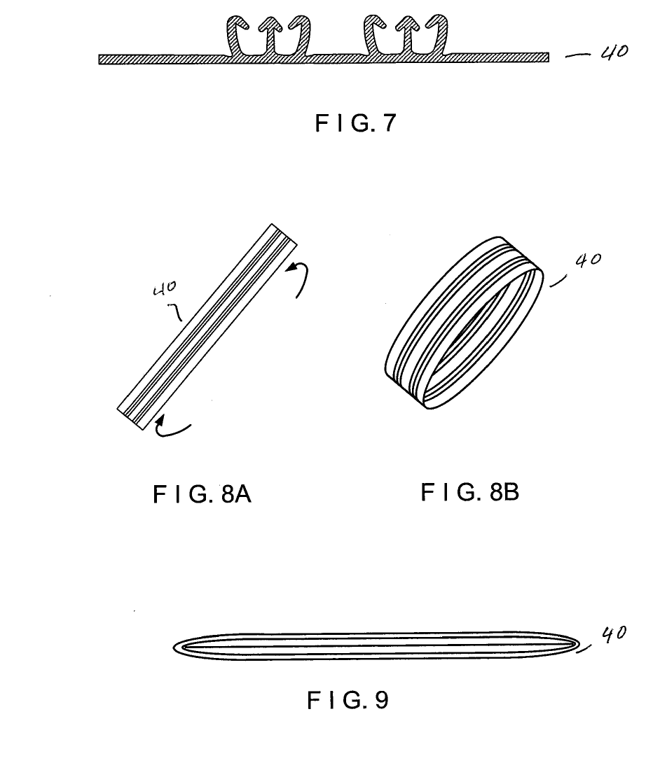

The fourth embodiment of the present disclosure is illustrated in FIGS. 7-12. In this embodiment, pre-looped zipper is applied in the machine direction, inboard of the pouch side welds or seams. This is intended to allow the zipper to open up and expand to a full mouth openings. In contrast, having a zipper within the side welds or seams would constrain the ends, typically preventing the desired full mouth opening.

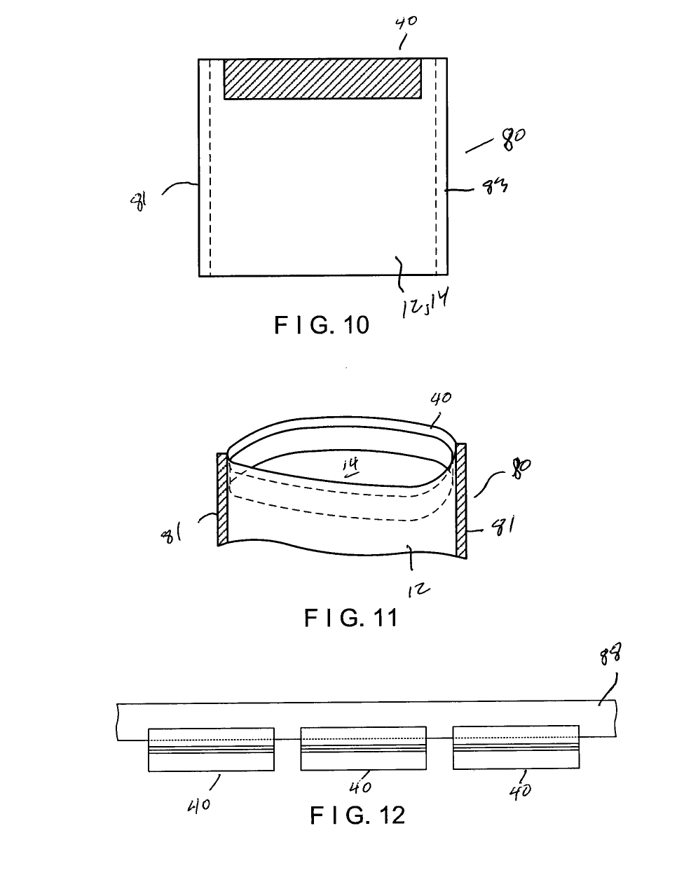

In the fourth embodiment, a zipper segment 40, typically of double unisex construction, is cut as shown in the cross section of FIG. 7 and then formed into a loop by joining the two ends thereof as shown in FIGS. 8A and 8B. The resulting loop is then compressed, joining the profiles as shown in FIG. 9. The resulting compressed loop is sealed into the pouch 80, inboard of the side seals 81, 83 as shown in FIG. 10. By not sealing to the side seals 81, 83, the looped zipper segment 40 can open back up to a side mouth opening as shown in FIG. 11. The springiness of the zipper segment 40 can be adjusted by selection of the zipper flange material of construction, using stiffer material to achieve a more positive mouth opening. FIG. 12 illustrates an potential method of introducing the zipper segment 40 into the pouch machine. The looped zipper segments 40 are sealed to a carrier web 88 which is used to transport the zipper segments 40 to the pouch machine.

The fourth embodiment of the present disclosure thereby achieves a reclosable pouch, package or bag with a wide mouth opening feature that will stay open when in an unlocked configuration.

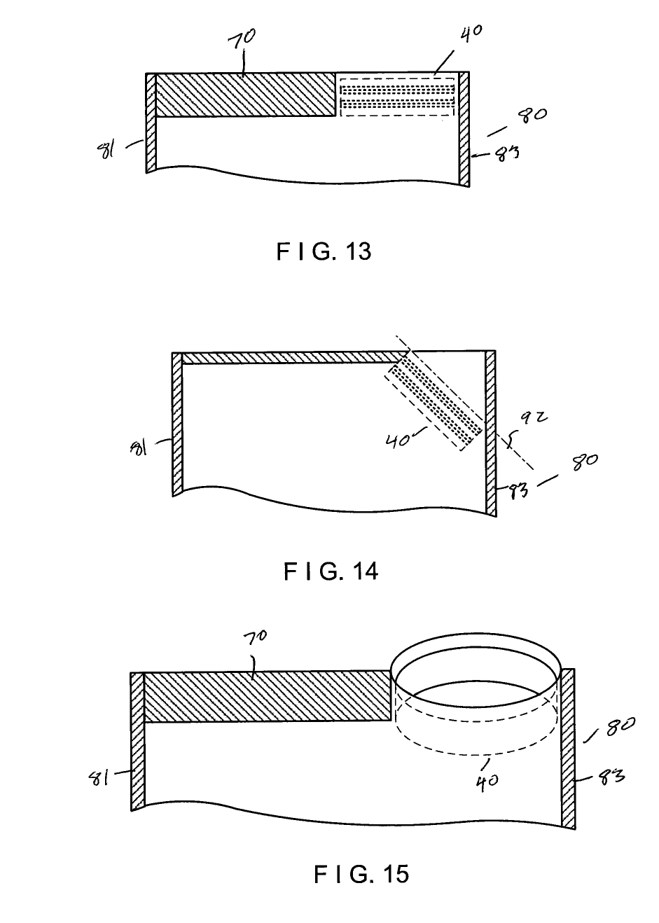

The fifth embodiment of the present disclosure builds upon the fourth embodiment, but utilizes a smaller zipper loop that only partially covers one side of the package thereby forming a spout. Further, the placement of the looped zipper segment 40 is not limited to transverse direction or pre-applied methods, machine direction placement can be implemented. As with the fourth embodiment, a zipper segment 40 is cut as shown in FIG. 7 and then formed into a loop by joining the two ends thereof as shown in FIGS. 8A and 8B. The resulting loop is then compressed, joining the profiles as shown in FIG. 9. Then, as shown in FIG. 12, the looped zipper segments 40 are sealed to a carrier web 88 which is used to transport the zipper segments 40 to the pouch machine. In the fifth embodiment, the zipper segment 40 is made to be smaller than the width of the package into which it is sealed. Typically, a spout segment 90 would be fifty percent or less than the width of the package side. FIGS. 13 and 15 illustrate the closed and open configurations, respectively, of a pouch 80 wherein the zipper segment 40 is placed into the top of the pouch 80, with a sealed header portion 70 over a portion of the top of the pouch 80. FIG. 12 illustrates an alternative wherein the spout segment 90 is placed at an angle, such as but not limited to forty-five degrees, to the top of pouch 80, with a line of weakness 92 formed above the zipper segment 40 in order to allow access to the zipper segment. Line of weakness 92 may be formed as a laser score, perforation or by other methods for creating a line of weakness serving as a tear line.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A method for manufacturing reclosable packages, including the steps of:
providing a web moving in a machine direction;
sealing a zipper across the web in a transverse direction;
folding the web and zipper thereby forming the zipper into a loop; and
forming a lower seal in the web, thereby forming a bottom seal in the package, while avoiding formation of any end stomps in the zipper, thereby maintaining the zipper in a loop, and maintaining a tendency of the zipper to urge the reclosable package to an open configuration.

2. The method of claim 1 wherein the zipper is a unisex zipper.

3. The method of claim 1 wherein the zipper is a multiple alignment zipper.

4. The method of claim 2 wherein the zipper includes one flange.

5. The method of claim 2 wherein the zipper includes two flanges.

6. The method of claim 1 wherein the zipper extends around the entire inner circumference of the resulting package.

7. The method of claim 1 wherein the step of folding the web and zipper further forms first and second walls of the package.

8. The method of claim 1 wherein the step of folding the web and zipper further forms the package in a tubular shape.

9. A method for manufacturing reclosable packages, including the steps of:
providing a web moving in a machine direction;
sealing a zipper across the web in a transverse direction;
folding the web and zipper thereby forming the zipper into a loop;
forming a lower seal in the web while avoiding formation of any end stomps in the zipper; and
wherein the zipper includes an interlocking element, a first flange and a peel seal on the flange.

10. The method of claim 9 wherein the interlocking element is notched so as to be shortened.

11. The method of claim 10 wherein the interlocking element includes a first end and a second end, and wherein a first notch is formed at the first end and a second notch is formed at the second end.

12. The method of claim 10 wherein the zipper is a unisex zipper.

13. The method of claim 10 wherein the zipper is a multiple alignment zipper.

14. The method of claim 10 wherein the zipper includes a second flange.

15. The method of claim 10 wherein the zipper extends around the entire inner circumference of the resulting package.

16. The method of claim 10 further including the step of forming a fin seal with the edges of the web after the step of folding the web and the zipper.

17. The method of claim 11 wherein the step of forming the fin seal includes the step of folding the first and second notches into the fin seal.

18. A method of forming a package, including the steps of:
providing a plurality of zipper segments;
looping the zipper segments;
compressing the zipper segments; and
sealing the zipper segments to an interior of a tube of film.

19. The method of claim 18 wherein the zipper segment is formed along only a portion of the top of the package thereby forming a spout.

20. The method of claim 18 wherein the zipper segment is sealed at an angle of substantially forty-five degrees to the top of the package thereby forming a spout.
